(19) United States
(12) Patent Application Publication
(10) Pub. No.: US 2022/0275256 A1
(43) Pub. Date: Sep. 1, 2022

(54) TRANSFER TAPE COMPRISING ADHESIVE FOR A PROTECTIVE WRAP

(71) Applicant: NIROTEK A.C.S. LTD., Kibbutz Nir-David (IL)

(72) Inventor: Uri RIMON, Kiryat Tivon (IL)

(21) Appl. No.: 17/735,951

(22) Filed: May 3, 2022

Related U.S. Application Data
(63) Continuation-in-part of application No. 17/720,562, filed on Apr. 14, 2022.
Application No. 17/720,562 is a continuation-in-part of application No. 14/759,646, filed on Jul. 7, 2015, now abandoned.
(60) Provisional application No. 61/807,784, filed on Apr. 3, 2013.
(60) Provisional application No. 61/753,452, filed on Jan. 17, 2013.

(51) Int. Cl. C09J 7/38; B65D 65/02; C09J 11/04; C09J 11/06

(52) U.S. Cl. CPC C09J 7/385; B65D 65/02; C09J 7/383; C09J 11/04; C09J 11/06; C09J 2301/1242; C09J 2301/408; C09J 2433/00; C09J 2421/00

(57) ABSTRACT

The present invention provides in a protective wrap for a product to be left in the open air, a transfer tape 100 useful for joining said protective wrap's outer layer 210 to said protective wrap's inner layer 270, said transfer tape 100 having: a. at least one outer adhesive layer 120 adapted to adhere at least one UV protective film 130 to said protective wrap's outer layer 210; b. said at least one UV protective film 130 connected on a first side to said outer adhesive layer 120; and c. at least one inner adhesive layer 140 connected to a second side of said at least one UV protective film 130, said inner adhesive layer 140 adapted to adhere to said protective wrap's inner layer 270.

### CROSS REFERENCE TO RELATED APPLICATIONS

This application is a continuation-in-part of U.S. patent application Ser. No. 17/720,562, filed on Apr. 14, 2022, which is a continuation-in-part of U.S. patent application Ser. No. 14/759,646, filed Jul. 7, 2015, which is a National Phase of PCT Patent Application No. PCT/IL2014/050057 having International filing date of Jan. 16, 2014, which claims the benefit of priority of U.S. Provisional Patent Application Nos. 61/807,784, filed Apr. 4, 2013 and 61/753,452 filed Jan. 17, 2013, the contents of which are all incorporated herein by reference in their entirety.

### FIELD OF THE INVENTION

The present invention generally pertains to a system and method for creating a product comprising an adhesive useful as a means of closure for a protective wrap for products stored for long periods of time in the open air.

### BACKGROUND OF THE INVENTION

Agricultural products such as cotton are frequently harvested and baled and then left for up to several months in the open field. The baled products are exposed to extremes of temperature, rain, wind and sunlight, the UV in the last tending to degrade adhesives in the wrapping. Wind, and especially high temperatures can cause the wrapping to fail, exposing the product and allowing it to be scattered.

There are many products in the prior art intended to bale such agricultural products.

One of the better prior art wrap products comprises a wrap film which is applied in several layers, with an adhesive between the two outer layers. Although this product works reasonably well when applied under clean conditions, the dust, dirt and particles of crop tend to degrade the quality of the adhesive bond and can cause the wrap to fail under certain harsh conditions of extended open-air storage.

It is therefore a long felt need to provide a product comprising an adhesive useful for creating a protective wrap for products stored for long periods of time in the open air.

### SUMMARY OF THE INVENTION

It is an object of the present invention to disclose, in a protective wrap for a product to be left in the open air, a transfer tape 100 useful for joining the protective wrap's outer layer 210 to the protective wrap's inner layer 270, the transfer tape 100 having:
a. at least one acrylic-based adhesive 120 adapted to adhere at least one UV protective film 130 to the protective wrap's outer layer 210;
b. the at least one UV protective film 130 connected on a first side to the acrylic-based adhesive 120; and
c. at least one rubber-based adhesive 140 connected to a second side of the at least one UV protective film 130, the rubber-based adhesive 140 adapted to adhere to the protective wrap's inner layer 270.

It is another object of the present invention to disclose, in a protective wrap for a product to be left in the open air, a transfer tape, as disclosed in any of the above, wherein at least one of the following is being held true (a) the coat-weight of the acrylic-based adhesive 120 is in the range of 20 gm/m² and 60 gm/m²; (b) the transfer tape 100 is adherable to the protective wrap's outer layer 210 under industrial conditions and is adherable to the protective wrap's inner layer 270 under field conditions; (c) the first adhesive comprises a UV resistant adhesive; (d) the coat-weight of the rubber-based adhesive 140 is in the range of 50 gm/m² and 120 gm/m²; (e) the transfer tape additionally comprising a dispersion of particulate UV blocking material 125; further wherein the particulate UV blocking material 125 comprises at least one pigment; wherein the at least one pigment comprises a member of a group consisting of titanium oxide, zinc oxide, and any combination thereof.

It is another object of the present invention to disclose, in a protective wrap for a product to be left in the open air, a transfer tape, as disclosed in any of the above, wherein the at least one acrylic-based adhesive 120 additionally comprises at least one UV protective material; further wherein at least one of the following is being held true (a) the at least one UV protective material comprises an additive selected from a group consisting of: UVA reflectors, UVB reflectors, UVA absorbers, UVB absorbers, and any combination thereof; (b) the at least one UV protective material comprises at least one photostabilizer; the at least one photostabilizer comprises HALS (hindered amine light stabilizer); and any combination thereof.

It is another object of the present invention to disclose, in a protective wrap for a product to be left in the open air, a transfer tape, as disclosed in any of the above, wherein the one acrylic-based adhesive 120 has a bond build time of at least 24 hours and the rubber-based adhesive 140 is characterized as having a strong initial tack-strength.

It is another object of the present invention to disclose, in a protective wrap for a product to be left in the open air, a transfer tape, as disclosed in any of the above, wherein the rubber-based adhesive 140 is characterized as having and initial tack-strength of at least >20 N/mm.

It is an object of the present invention to disclose a protective wrap for a product to be left in the open air comprising
a. an outer protective layer 210;
b. an inner protective layer 270; and
c. a transfer tape 100 for joining the outer and the inner protective layers
   wherein the transfer tape 100 comprises at least one acrylic-based adhesive 120 adapted to adhere the at least one UV protective film 130 to the outer layer 210; at least one UV protective film 130 connected to a first side of the acrylic-based adhesive 120; and at least one rubber-based adhesive 140 connected to a second side of the at least one UV protective film 130.

It is another object of the present invention to disclose, the protective wrap of any of the above, wherein at least one of the following are being held true (a) the coat-weight of the acrylic-based adhesive 120 of the transfer tape 100 is in the range of 20 gm/m² and 60 gm/m²; (b) the protective wrap's outer layer 210 is adherable to the transfer tape 100 under industrial conditions and the protective wrap's inner layer 270 is adherable to the transfer tape 100 under field conditions; (c) the first adhesive comprises a UV resistant adhesive; (c) the coat-weight of the rubber-based adhesive 140 of the transfer tape 100 is in the range of 50 gm/m² and 120 gm/m²; (d) the protective wrap additionally comprising a dispersion of particulate UV blocking material 125; the particulate UV blocking material 125 comprises at least one pigment; further wherein the at least one pigment comprises a member of a group consisting of titanium oxide, zinc oxide and any combination thereof; and any combination thereof.

It is another object of the present invention to disclose, the protective wrap of any of the above, wherein the at least one acrylic-based adhesive 120 additionally comprises at least one UV protective material; further wherein at least one of the following is being held true (a) the at least one UV protective material comprises an additive selected from a group consisting of: UVA reflectors, UVB reflectors, UVA absorbers, UVB absorbers, and any combination thereof; (b) the at least one UV protective material comprises at least one photostabilizer; further wherein the at least one photostabilizer comprises HALS (hindered amine light stabilizer).

It is another object of the present invention to disclose, the protective wrap of any of the above, wherein the acrylic-based adhesive 120 is characterized as having a strength building period of at least 24 hours and the rubber-based adhesive 140 is characterized as having a strong initial tack-strength.

It is another object of the present invention to disclose, the protective wrap of any of the above, wherein the rubber-based adhesive 140 is characterized as having and initial tack-strength of at least >20 N/mm.

It is an object of the present invention to disclose a transfer tape product for storage and transportation of a transfer tape 100 comprising:
a. an outer cover layer 510 releasably attached to a first side of the transfer tape 100;
b. a central carrier layer 350 with a first side releasably attached to a second side of the transfer tape 100;
c. an adhesive 360 with first side attached to a second side of the central carrier layer 350; and
d. an inner cover layer 370 releasably attached to a second the of the adhesive 360
   wherein the transfer tape 100 comprises at least one acrylic-based adhesive 120 adapted to adhere the transfer tape 100 to the outer layer 510; at least one UV protective film 130 connected to a first side of the acrylic-based adhesive 120; and at least one rubber-based adhesive 140 connected to a second side of the at least one UV protective film.

It is another object of the present invention to disclose, the transfer tape product of any of the above, wherein, wherein at least one of the following is being held true (a) the coat-weight of the acrylic-based adhesive 120 is in the range of 20 gm/m² and 60 gm/m²; (b) the first adhesive comprises a UV resistant adhesive; (c) the coat-weight of the rubber-based adhesive 140 is in the range of 50 gm/m² and 120 gm/m²; (d) the transfer tape additionally comprising a dispersion of particulate UV blocking material 125; further wherein the particulate UV blocking material 125 comprises at least one pigment; the at least one pigment comprises a member of a group consisting of titanium oxide, zinc oxide and any combination thereof.

It is another object of the present invention to disclose, the transfer tape product of any of the above, wherein, wherein the at least one acrylic-based adhesive 120 additionally comprises at least one UV protective material; wherein the at least one UV protective material comprises an additive selected from a group consisting of: UVA reflectors, UVB reflectors, UVA absorbers, UVB absorbers, and any combination thereof further wherein the at least one UV protective material comprises at least one photostabilizer; wherein the at least one photostabilizer comprises HALS (hindered amine light stabilizer).

It is another object of the present invention to disclose, the transfer tape product of any of the above, wherein, wherein the acrylic-based adhesive 120 is characterized as having a strength building period of at least 24 hours and the rubber-based adhesive 140 is characterized as having a strong initial tack-strength.

It is another object of the present invention to disclose, the transfer tape product of any of the above, wherein, wherein the rubber-based adhesive 140 is characterized as having and initial tack-strength of at least >20 N/mm.

It is the object of the present invention to disclose a method of producing a transfer tape 100 comprising steps of:
a. providing a UV protective film 130;
b. attaching at least one acrylic-based adhesive 120 to a first side of the UV protective film 130; and
c. attaching at least one rubber-based adhesive 140 to a second side of the UV protective film 130.

It is another object of the present invention to disclose, the method of any of the above, additionally comprising at least one step selected from a group consisting of (a) selecting the coat-weight of the acrylic-based adhesive 120 to be in the range of 20 gm/m² and 60 gm/m²; (b) selecting a UV resistant adhesive for the acrylic-based adhesive 120; (c) selecting the coat-weight of the rubber-based adhesive 140 to be in the range of 50 gm/m² and 120 gm/m²; (d) providing the transfer tape 100 with a dispersion of particulate UV blocking material 125; the particulate UV blocking material 125 to be at least one pigment; the at least one pigment I selected from a group consisting of titanium oxide, zinc oxide and any combination thereof.

It is another object of the present invention to disclose, the method of any of the above, additionally comprising steps of providing at least one UV protective material within the at least one acrylic-based adhesive 120; further wherein the method additionally comprising at least one step selected from (a) selecting the at least one UV protective material to be an additive selected from a group consisting of: UVA reflectors, UVB reflectors, UVA absorbers, UVB absorbers, and any combination thereof; further wherein providing at least one photostabilizer as the at least one UV protective material; further wherein selecting the at least one photostabilizer to be HALS (hindered amine light stabilizer).

It is the object of the present invention to disclose a method for producing a protective wrap for a product to be left in the open air, the method comprising steps of:
a. providing the protective wrap's outer layer 210;
b. providing the protective wrap's inner layer 270;
c. providing a transfer tape 100 comprising:
   a. at least one acrylic-based adhesive 120 adapted to adhere at least one UV protective film 130 to the protective wrap's 210 outer layer;
   b. the at least one UV protective film 130 connected on a first side to the acrylic-based adhesive 120;
   c. at least one rubber-based adhesive 140 connected on a first side to a second side of the at least one UV protective film 130, the rubber-based adhesive 140 adapted to adhere to the protective wrap's 270 inner layer;
d. adhering the protective wrap's outer layer 210 to a first side of the at least one UV protective film 130;
e. wrapping the protective wrap's inner layer 270 around the product such that a second side of the protective wrap's inner layer 270 faces the product;
f. adhering a first side of the protective wrap's inner layer 270 to a second side of the at least one rubber-based adhesive 140.

It is another object of the present invention to disclose, the method of any of the above, wherein the steps of adhering the protective wrap's outer layer 210 to a first side of the acrylic-based adhesive 120 are carried out under industrial conditions and the steps of adhering the protective wrap's inner layer 270 to a second side of the rubber-based adhesive 140 are carried out under field conditions.

It is another object of the present invention to disclose, the method of any of the above, additionally comprising at least one step selected from a group consisting of (a) selecting the coat-weight of the acrylic-based adhesive 120 to be in the range of 20 gm/m² and 60 gm/m²; (b) selecting a UV resistant adhesive for the first adhesive; (c) selecting the coat-weight of the rubber-based adhesive 140 to be in the range of 50 gm/m² and 120 gm/m²; (c) providing the protective wrap with a dispersion of particulate UV blocking material 125; the particulate UV blocking material 125 is at least one pigment; the at least one pigment is selected from a group consisting of titanium oxide, zinc oxide and any combination thereof; (d) providing at least one UV protective material within the at least one acrylic-based adhesive 120; the at least one UV protective material is an additive selected from a group consisting of selected from a group consisting of: UVA reflectors, UVB reflectors, UVA absorbers, UVB absorbers, and any combination thereof.

It is another object of the present invention to disclose, the method of any of the above, additionally comprising a step of building adhesion strength.

It is another object of the present invention to disclose, the method of any of the above, wherein the step is characterized as having a maturing time of at least 24 hours.

It is the object of the present invention to discloses a method of producing a protective wrap for a product to be left in the open air comprising steps of:
a. providing an outer protective layer 210;
b. providing an inner protective layer 270;
c. providing a transfer tape 100 for joining the outer 210 and the inner 270 protective layers;
d. wrapping the inner protective layer 270 around the product such that a second side of the inner protective layer 270 faces the product;
e. adhering a second side of the transfer tape 100 to a first side of the inner protective layer 270; and
f. adhering a first side of the transfer tape 100 to the outer protective layer 210 wherein the transfer tape 100 comprises at least one acrylic-based adhesive 120 adapted to adhere a first side of at least one UV protective film 130 to the outer protective layer 210; and at least one rubber-based adhesive 140 connected to a second side of the at least one UV protective film 130.

It is another object of the present invention to disclose, the method of any of the above, wherein the steps of adhering the protective wrap's outer layer 210 to a first side of the acrylic-based adhesive 120 are carried out under industrial conditions and the steps of adhering the protective wrap's inner layer 270 to a second side of the rubber-based adhesive 140 are carried out under field conditions.

It is another object of the present invention to disclose, the method of any of the above, wherein the acrylic-based adhesive 120 is characterized as having a strength building period of at least 24 hours and the rubber-based adhesive 140 is characterized as having a strong initial tack-strength.

It is another object of the present invention to disclose, the method of any of the above, wherein the rubber-based adhesive 140 is characterized as having and initial tack-strength of at least >20 N/mm.

It is another object of the present invention to disclose, the method of any of the above, additionally comprising at least one step selected from a group consisting of (a) selecting the coat-weight of the acrylic-based adhesive 120 to be in the range of 20 gm/m² and 60 gm/m²; (b) selecting a UV resistant adhesive for the first adhesive; (c) selecting the coat-weight of the rubber-based adhesive 140 to be in the range of 50 gm/m² and 120 gm/m²; (d) providing the protective wrap with a dispersion of particulate UV blocking material 125; the particulate UV blocking material 125 is at least one pigment; the at least one pigment is selected from a group consisting of titanium oxide, zinc oxide and any combination thereof; (e) providing at least one UV protective material within the at least one acrylic-based adhesive 120; the at least one UV protective material is an additive selected from a group consisting of: UVA reflectors, UVB reflectors, UVA absorbers, UVB absorbers, and any combination thereof.

It is the object of the present invention to discloses, in a protective wrap for a product to be left in the open air, a transfer tape 800 useful for joining the protective wrap's outer layer 210 to the protective wrap's inner layer 270, the transfer tape 800 having:
a. at least one acrylic-based adhesive 120 adapted to adhere to the protective wrap's outer layer 210; and
b. at least one rubber-based adhesive 140 connected to a second side of the at least one acrylic-based adhesive 120, the rubber-based adhesive 140 adapted to adhere to the protective wrap's inner layer 270
   wherein at least one of the following is held true: the at least one acrylic-based adhesive 120 comprises at least one UV protective material, and at least one layer of particulate UV blocking material 125 is disposed between the acrylic-based adhesive 120 and the rubber-based adhesive 140.

It is another object of the present invention to disclose, the transfer tape of any of the above, wherein at least one of the following is being held true (a) the particulate UV blocking material 125 comprises at least one pigment; (b) the at least one pigment comprises a member of a group consisting of titanium oxide, zinc oxide and any combination thereof the at least one UV protective material comprises an additive selected from a group consisting of: UVA reflectors, UVB reflectors, UVA absorbers, UVB absorbers, and any combination thereof; (c) the at least one UV protective material comprises at least one photostabilizer; the at least one photostabilizer comprises HALS (hindered amine light stabilizer); (d) the transfer tape 800 is adherable to the protective wrap's outer layer 210 under industrial conditions and to the protective wrap's inner layer 270 under field conditions; (e) the coat-weight of the acrylic-based adhesive 120 is in the range of 20 gm/m² and 60 gm/m²; (f) the first adhesive comprises a UV resistant adhesive; (g) the coat-weight of the rubber-based adhesive 140 is in the range of 50 gm/m² and 120 gm/m²; and any combination thereof.

It is another object of the present invention to disclose, the transfer tape of any of the above, wherein the acrylic-based adhesive 120 is characterized as having a strength building period of at least 24 hours and the rubber-based adhesive 140 is characterized as having a strong initial tack-strength.

It is another object of the present invention to disclose, the transfer tape of any of the above, wherein the rubber-based adhesive 140 is characterized as having and initial tack-strength of at least >20 N/mm.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1 schematically illustrates an embodiment of the transfer tape;

FIG. 2A-B schematically illustrates a wrap comprising the present invention;

FIG. 3 schematically illustrates sub-product 1, at the end of the first step of processing;

FIG. 4 schematically illustrates sub-product 2, at the end of the second step of processing;

FIG. 5 schematically illustrates an embodiment of a storable product comprising the transfer tape;

FIG. 6A-B schematically illustrates a wrap-ready product;

FIG. 7A-B schematically illustrates a method of wrapping a product which creates a protective wrapping from a wrap-ready product;

FIG. 8 schematically illustrates another embodiment of the transfer tape;

FIG. 9A-B schematically illustrates a wrap comprising the present invention;

FIG. 10 schematically illustrates sub-product 1, at the end of the first step of processing;

FIG. 11 schematically illustrates an embodiment of a storable product comprising the transfer tape;

FIG. 12A-B schematically illustrates a wrap-ready product; and

FIG. 13A-B schematically illustrates a method of wrapping a product which creates a protective wrapping from a wrap-ready product.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide a means and method for creating a product comprising an adhesive useful as a means of closure for a protective wrap for products stored for long periods of time in the open air.

The term ‘industrial conditions’ hereinafter refers to controlled production conditions, such as are typically found in a factory. Typically, industrial conditions include at least some control of temperature, air cleanliness and surface cleanliness. Typically, under industrial conditions, no free water, free grease or free oil is present, and neither are chaff or other plant products, or pebbles, dirt, grit or other contaminants,

The term ‘field conditions’ hereinafter refers to uncontrolled production conditions, such as occur, for non-limiting example, during harvesting in an open field. Under field conditions, it is not feasible to control factors such as, but not limited to, dampness of the product, temperature, presence of free water, free grease or free oil, or presence of contaminants such as chaff or other plant products, pebbles, dirt, or grit.

The term ‘inner’ hereinafter refers to an item closer to the center of the cotton bale or other wrapped object than another, similar item.

The term ‘outer’ hereinafter refers to an item further from the center of the cotton bale or other wrapped object than another, similar item. For non-limiting example, the inner wrap layer is closer to the center of the wrapped item than the outer wrap layer; the outer wrap layer at least partially covers the inner wrap layer and so that the outer wrap layer protects the covered portions of the inner wrap layer from the elements.

The term ‘about’ hereinafter refers to a range of 25% around a given value.

Throughout, the same number will refer to the same object, and similar numbers refer to objects with similar functions.

The present invention discloses a system and method for producing a transfer tape which is capable of serving as a closure tape for a protective wrap to be used in outdoor and agricultural applications, such as, for non-limiting example, for the baling and storage of crops such as cotton.

Such a wrap must satisfy several criteria:
1. It must withstand rain without damage and must protect the underlying product against the wet.
2. It must withstand sunshine, especially UV, without significant degradation of its protective function.
3. It must withstand high temperatures. The temperature of the wrap materials, on a hot day in full sunshine, can reach 60° C.
4. It must withstand wind without failure. One common cause of wind-driven failure is for the wind to raise a free edge of the wrap, thereby causing failure of the wrap. An example of this is where the protective wrap comprises a wrapping material which encircles the product. The ends of the encircling wrapping material overlap; adhesive between the overlapped ends holds the protective wrapping in place. If the adhesive ends sufficiently far from the free end of the outermost overlapped edge or if there is a partial failure of the adhesive due, for example, to UV which reaches the free end of the outermost overlapped edge, the wind can lift the overlapped edge or tunnel into the overlapped edge via the failure, thereby forcing apart the overlapped layers, causing further failure of the adhesive and eventually causing the adhesive to fail entirely so that the protective wrapping fails.
5. It must withstand internal pressure from the cotton. Cotton is baled under pressure so that, during storage, the cotton will attempt to expand. This expansion puts outward pressure on the protective wrap which can only be relieved by increasing the diameter of the bale. Since the protective wrap film can only stretch to a limited degree without affecting the closure area, further expansion of the bale can only take place if the wrap layers slide relative to each other. Such expansion creates shear forces in the wrap's adhesive layers that can be quite large. These large shear forces can lead to failure of the adhesive layer, especially under high temperature conditions (up to 60° C.), where adhesives can soften and lose internal structural strength.
6. At least the final step of production of the protective wrap must be capable of being carried out under field conditions, which include conditions likely to interfere with producing a high-quality, long-lasting protective wrap such as:
   a. Presence of airborne dust.
   b. Presence of byproducts such as chaff, particles of product, leaves, stems or seeds.
   c. Presence of dirt, grit, pebbles or other solid contaminants.
   d. Humidity in the air.
   e. Rain or other sources of free water.
   f. Presence of other fluids, such as plant juices or oils and greases from machinery.
   g. Uncontrolled temperature. For example, air temperature during harvesting can be as low as about −20° C. and as high as about 45° C., and can vary over 20° C. during the course of a day.

The transfer tape of the present invention, when used in conjunction with appropriate wrapping films, provides a protective wrapping that satisfies the above criteria.

The transfer tape is intended to be transformed into a protective wrap in stages. The end product of the first stage, produced under industrial conditions, is a transfer tape product with at least external releasable cover layers and, in preferred embodiments, at least one internal releasable separation (carrier) layer. This transfer tape product is capable of withstanding both rough handling and long-term storage without losing efficacy.

During the second stage, also carried out under industrial conditions, the external cover layers are removed from the transfer tape product and are replaced with wrapping material. It is during this stage that the outer adhesive layer is adhered to the outer wrap layer. At this stage, the inner wrap layer is adhered to a third adhesive layer, not to the inner adhesive layer. The inner wrap layer remains releasably attached to an internal releasable separation (carrier) layer. In some embodiments, there is a period of bond strengthening of at least 24 hours, between stage 2 and stage 3.

During the third stage, carried out under field conditions, the second stage product is wrapped around the material to be protected, the remaining separation (carrier) layer or layers are detached, and the portions of the final wrap (disjoint after removal of the separation layer(s)) are joined together by means of the freshly-exposed adhesive layer(s), forming the final protective wrap. All of these stages are described in more detail herein below.

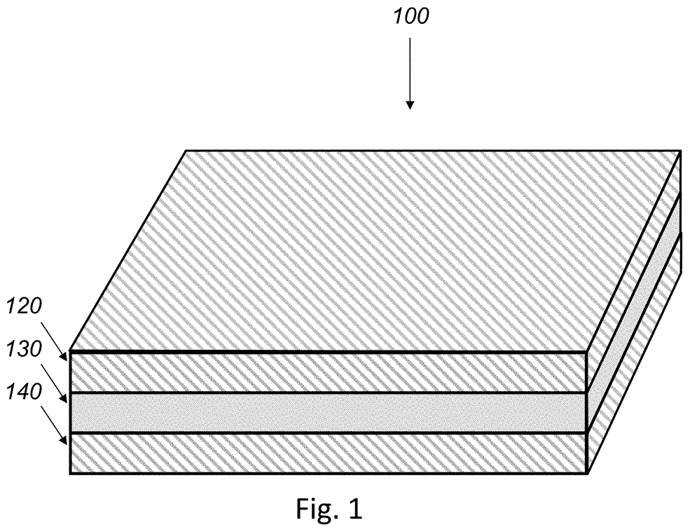

An embodiment of the transfer tape (100) is shown in FIG. 1. The transfer tape comprises a UV protective film 130 sandwiched between two layers of adhesive, an outer adhesive layer (120) which comprises a UV-resistant adhesive applied at a coat weight of between about 20 gm/m² and about 60 gm/m², and an inner adhesive layer (140) applied at a coat weight of between about 50 gm/m² and about 120 gm/m².

In preferred embodiments, the adhesives are pressure-sensitive adhesives. However, adhesives used for the adhesive layers can be any adhesive known in the art with the desired properties, as described hereinbelow.

Typically, the outer adhesive layer (120) comprises an acrylic adhesive and the inner adhesive layer (140) comprises a rubber-based adhesive. However, any UV-resistant and water-resistant adhesive of suitable strength can be used in the outer adhesive layer (120) and any water-resistant adhesive of suitable strength can be used in the inner adhesive layer (140). In some embodiments, the inner adhesive (140) has a strong initial-tack strength, in particular in field conditions, with a short time to build bond strength. In some embodiments, the initial tack-strength of the inner adhesive is >20 N/mm (as measured by loop tack). In some embodiments, the outer adhesive (120) builds up bond strength for at least 24 hours.

The outer adhesive layer (120) can comprise a UV-cured adhesive, a solvent-borne adhesive, a water-borne adhesive or a hot-melt (solvent-less) adhesive.

In order to increase the UV protection provided to the inner adhesive layer (140), the outer adhesive layer (120) can comprise additives to block UV radiation. If the outer adhesive layer (120) comprises a UV-cured adhesive, the additives can block or absorb UVA (wavelengths 320-400 nm) and UVB radiation (wavelengths 280-320 nm) but must not block or absorb UVC radiation (wavelengths 100-280 nm), which induces crosslinking of the adhesive.

The outer adhesive layer can also comprise components such as photostabilizers exemplified by, but not limited to, HALS—hindered amine light stabilizers, as well as free radical scavengers and quenchers, which slow down the degradation of UVA/UVB absorbers and of the adhesive itself.

If the outer adhesive layer (120) is not UV-cured, it can additionally comprise physical light blockers, typically pigments such as, but not limited to, titanium oxide or zinc oxide.

UV protection can be further increased by addition of particulate UV blocking material (not shown). The UV blocking material can be applied as a dispersal throughout the adhesive or as at least one ultra-thin layer either in conjunction with or in place of a UV protective film (130), with the layer(s) thin enough to allow a large interface between the adhesive layers (120, 140) to which it is adjacent, so that good bonding between the layer(s) (120, 140) is achieved.

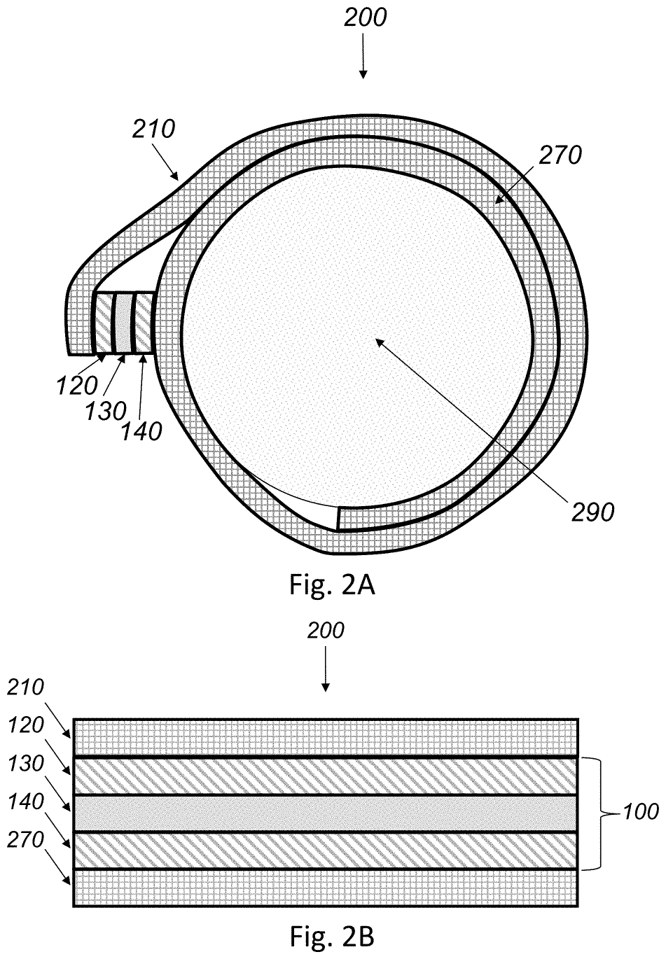

A protective wrap comprising the transfer tape is shown wrapping an exemplary bale of cotton (not to scale) in FIGS. 2A-B. FIG. 2A schematically illustrates the protective wrap as wrapped around the bale, while FIG. 2B schematically illustrates the layers making up the wrap. The bale of cotton (290) is surrounded by an inner wrap layer (270), with the wrap layer material selected from a wrapping material typical of those known in the art. Adhering to the outside of the end of the inner wrap layer (270) and bonding the end of the inner wrap layer to the UV protective film (130) is the inner adhesive layer (140). The outer adhesive layer (120) bonds the UV protective film (130) to the outer wrap layer (210).

In preferred embodiments, the external releasable cover layers comprise glassine release liner. In other embodiments, they can comprise any flexible releasable film with sufficient strength to withstand handling.

In preferred embodiments, the internal release liner (carrier layer) comprises PET film. In other embodiments, it can comprise any flexible releasable film with sufficient strength to withstand being mechanically separated from the transfer tape.

In preferred embodiments, the UV protective film blocks UV radiation by reflection and/or absorbance, thus protecting the inner adhesive.

The UV protective film can be comprised of a polyester film, or any other highly flexible film that permanently bonds to the desired adhesives. In preferred embodiments, the flexibility of the UV protective film is adjusted to minimize shearing forces caused by mismatch between the flexibility of the UV protective film and the flexibility of the wrap layers. This flexibility adjustment can be obtained by mechanical means, by chemical means, or by a combination thereof. Mechanical means typically comprise changing the thickness of the film or selecting a different film material. Chemical means include changing the fraction of plasticizers, fillers or binders in the film material, thereby changing the amount of cross-linking between polymer chains, or changing the molecular weight of the polymer chains—shorter (lighter) chains tend to be more flexible.

The outer adhesive layer (120), which, in the final protective wrapping, is outside the protection of the UV protective film, has the following properties:
As an adhesive agent:
   high hot shear resistance;
   high hot/cold peel resistance;
   good bonding under pressure to a plastic film substrate after long dwell time (weeks);
As a material:
   high resistance to the elements, including wetness (humidity and rain) and sunlight (UV radiation).

The inner adhesive layer, which, in the final protective wrapping, is inside the UV protective film, has the following properties:
As an adhesive agent:
   high hot shear resistance;
   high hot/cold peel resistance;
   high cold tack;
   good immediate bonding to plastic film substrate
As a material:
   high resistance to wetness (humidity and rain).
   Some resistance to UV radiation.

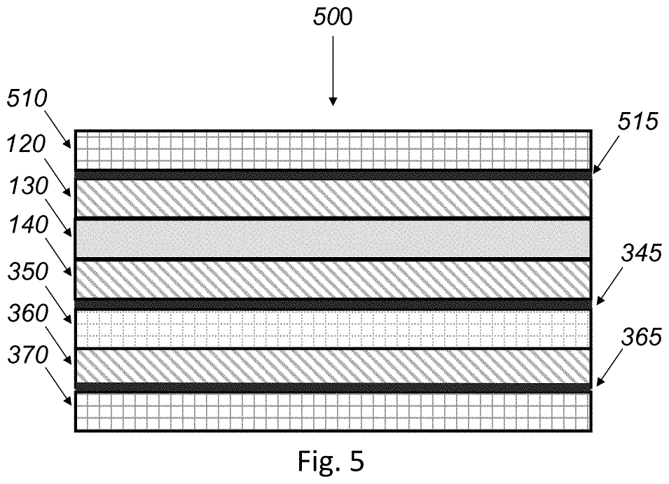

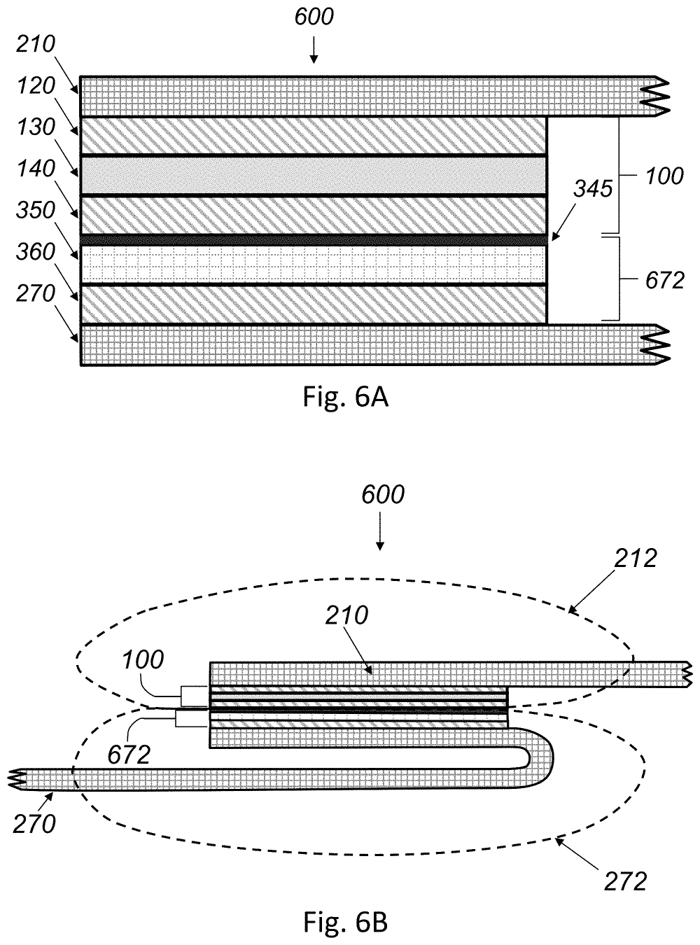

As described hereinabove, production of the wrapped product occurs in several stages, with the output of Stage 1 being a transfer tape product (500, FIG. 5, below), the output of Stage 2 being a wrap-ready product (600, FIG. 6, below), and the output of Stage 3 being an object, such as a bale of cotton, wrapped in, and protected by, the product (200, FIG. 2A).

The exemplary production flow presented herein (Stages 1-3) for a transfer tape product (500, FIG. 5, below) and, hence, a wrapped product with inner adhesive (140) protected by a UV protective film (130) is but one option for producing the laminate; there are alternative routes which can be used.

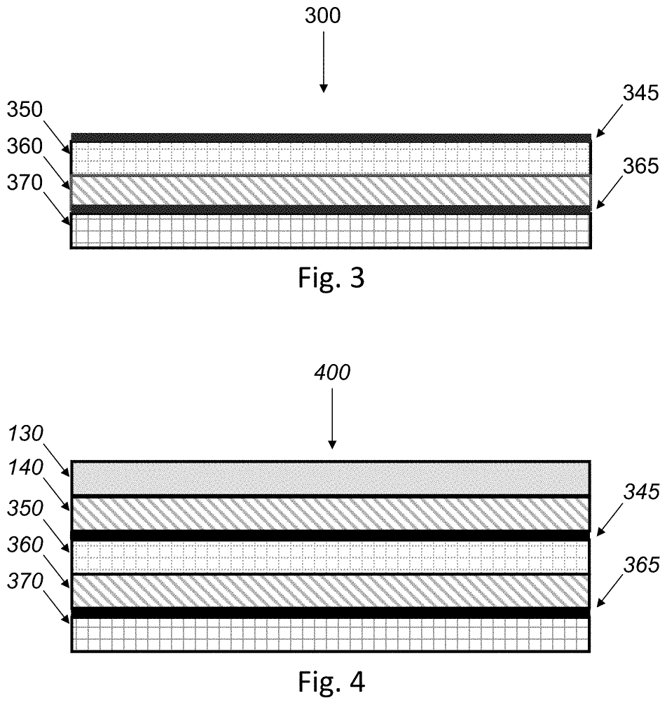

FIG. 3 shows the output of Step 1 of Stage 1, sub-product 1 (300). Sub-product 1 (300) is formed by coating a glassine release liner (the white glassine release liner) (370) with a release layer (365) on the release layer (365) side with about 30 gm/m² of permanent adhesive (360) (range 20-60 gm/m²), and laminating this with a siliconized PET release liner (350) with release layer (345), on its non-release layer side.

FIG. 4 shows the output of Step 2 of Stage 1, sub-product 2 (400). To form sub-product 2 (400), sub-product 1 (300) is coated, on the siliconized release layer side 345 of the PET release liner, with inner transfer adhesive(s) (140) (coat weight about 50-120 gm/m²) and the inner transfer adhesive(s) (140) is laminated with a UV-protective film (130).

FIG. 5 shows the output of Step 3 of Stage 1, a storable product, the transfer tape product (500), comprising a transfer tape (100) between two release layers. The transfer tape product (500) is formed by coating sub-product 2 (400), on the UV protective film (130) side, with outer adhesive(s) (120) (coat weight about 20-60 gm/m²), and laminating the outer adhesive(s) (120) with yellow glassine release liner (510), with the release side (515) of the yellow glassine release liner (510) facing the outer adhesive layer (120).

The transfer tape product (500) can withstand handling, transportation and storage for an indefinite length of time (the transfer tape is guaranteed for 2 years from tape production until the end of use in the field) and it is envisaged that the transfer tape product (500) will be marketed.

In order to form the protective wrap, two additional stages, Stage 2 and Stage 3, are required. It is intended that Stage 2, like Stage 1, occurs under controlled conditions, for example, in a customer's factory, where temperature and cleanliness are controlled and there is an absence of free water, although control of humidity is not necessary.

During Stage 2, the white (370) and yellow (510) release liners are removed from the transfer tape product (500); for convenience, the transfer tape product without release liners will be referred to as the linking tape (100, 672). After removal of the release liners (370, 510), the leading edge of one piece of wrap film (210, 270) is bonded to the freshly-exposed side of the permanent adhesive layer (360) on the inner side of the linking tape (100, 672), while the trailing edge of a second piece of wrap film (210, 270) is bonded to the freshly-exposed side of the outer adhesive layer (120).

It should be noted that the portion of the linking tape (100, 672) bonded to the leading edge of a piece of wrap film (210, 270) is bonded to the outer side of the piece of wrap film (210, 270), while the portion of the linking tape (100, 672) bonded to the trailing edge of the piece of wrap film (210, 270) is bonded to the inner side of the piece of wrap film (210, 270).

As the wrap film (210, 270) is intended to go approximately two times around the cotton bale or other wrapped object, for convenience, the portion of the wrap film (210, 270) intended to form the inner layer of the final wrap will be referred to herein as the inner wrap layer (270) and the portion of the wrap film (210, 270) intended to form the outer layer of the final wrap will be referred to herein as the outer wrap layer (210).

The width of the transfer tape is preferably at least 75% of the width of the wrap film, so the transfer tape extends at least ¾ of the way across at each end of the wrap film. The transfer tape is preferably positioned such that its center is approximately at the center of the width of the wrap film.

Typically, a portion of transfer tape is attached to the leading edge of one piece of wrap film (210, 270) and also to the trailing edge of a second piece of wrap film (210, 270). Therefore, production of wrap-ready material will result in a plurality of wraps linked end-to-end.

Removal of the release liners (370, 510) and attachment of the wrap film (210, 270) creates a wrap-ready product 600, as shown in FIG. 6A. FIG. 6A shows only the portion of the wrap ready product comprising the linking tape (100, 672); at least a portion and preferably the majority of both the inner (270) and outer (210) wrap layers are not in contact with linking tape (100, 672).

In FIG. 6A, the transfer tape, formed by the outer layers (100) of the linking tape (100, 672) are the layers (120, 130, 140) which are bonded to the trailing edge of one piece of wrap film and which will remain adhered to the outer wrap layer (270) in the final product, while the inner layers (672) of the linking tape (100, 672) are the layers (350, 360) which are bonded to the leading edge of a second piece of wrap film and will remain adhered to the inner wrap layer (210) in the final product.

FIG. 6B shows a larger portion of wrap ready product (600) comprising the linking tape (100, 672); the inner wrap layer (270) is folded back so that both the inner (270) and outer (210) wrap layers approach the transfer tape from the same side (in this non-limiting example, the right side).

The wrap-ready product can withstand handling, transportation, and storage for an indefinite length of time (it is guaranteed for 2 years). To be used, it is transported to the packing environment, usually an open field. In the field, the PET release liner (350) is removed, exposing the inner adhesive layer (140). The freshly-exposed adhesive layer (140) is then adhered to the wrap film (270), forming the final product, a protective wrap (200), as shown in FIG. 2.

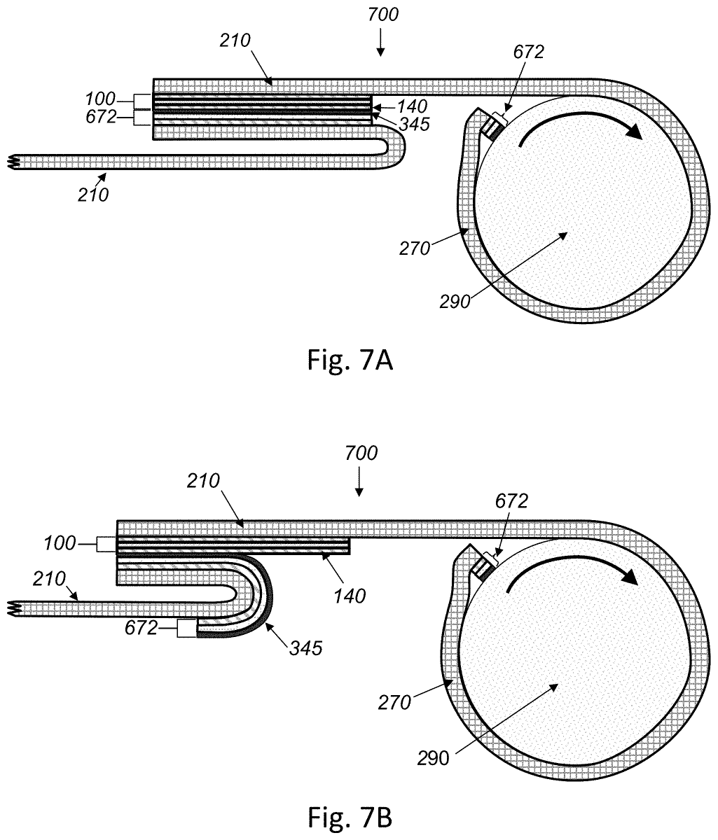

A schematic of an embodiment of an exemplary route (700) for adhering the inner adhesive layer (140) to the wrap film (210, 270) is shown schematically in FIGS. 7A, 7B. The process is shown after the wrapping process has started; the first wrap of the bale (290) is almost complete. The bale (290) is being rotated clockwise (CW), which pulls the wrap-ready product (600) from a roll or other storage means known in the art (not shown). In the exemplary embodiment shown schematically in FIGS. 7A and 7B, purely for convenience in illustration the roll (not shown) is at the left and the wrap-ready product is drawn from the left towards the bale. In practice, the roll can be in any desired orientation relative to the bale and the wrap-ready product can be drawn towards the bale from any desired direction.

In FIG. 7A, the trailing edge (270) of the current wrap and the leading edge (210) of the next wrap are shown in a fully-joined condition. In FIG. 7B, the trailing edge (270) of the current wrap and the leading edge (210) of the next wrap have partially separated.

FIG. 7B shows the process at a slightly later stage. The linking tape (100, 672) is separating between the PET release layer (345) and the inner adhesive layer (140), exposing the inner adhesive layer (140) in the transfer tape layers (100), with the inner tape layers (672) remaining attached to the leading edge of the inner wrap layer (270) of the next wrap film.

As the bale (290) continues to rotate, the transfer tape (100) and the outer tape layer (672) separate completely. The wrap film (210, 270) continues to wrap around the bale, forming an inner wrap layer (270) and an outer wrap layer (210). During completion of the second wrap, the transfer tape (100) at the end of the outer wrap layer (210) will be adhered to the inner wrap layer (270), thereby creating protective wrap 900.

It should be noted that a “tag” of wrap-ready product, comprising the inner tape layers (672), is left at the leading edge of the inner wrap layer (270).

Completion of two 360° rotations envelopes the bale (290) in a protective wrap (200) comprising two layers of wrapping film bonded together by a transfer tape (100). The transfer tape (100), which bonds the trailing end (270) of the wrap film to the inner wrap layer (210) comprises at least one internal UV protective layer (130) and at least one inner (140) and at least one outer (120) adhesive layer, where the outer adhesive layer (120) was bonded under controlled conditions and the inner adhesive layer (140) bonded under field conditions.

Therefore, the inner adhesive layer (140) is protected from wind, UV and wet, except at the edges, by the UV protective film (130) and the outer wrap layer (210), thereby providing a protective wrapping that can last up two years under field conditions.

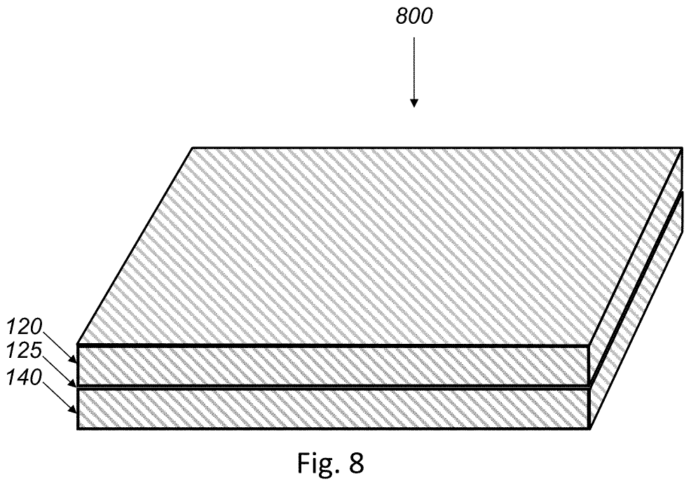

Other embodiments of the transfer tape (800) are shown in FIG. 8. In these embodiments, there is no UV protective film (130); the transfer tape (800) comprises two layers of adhesive, an outer adhesive layer (120) which comprises a UV-resistant adhesive applied at a coat weight of between about 20 gm/m² and about 60 gm/m², an inner adhesive layer (140) applied at a coat weight of about 50 gm/m² and about 120 gm/m² and, optionally, an ultra-thin layer of particulate UV blocking material (125), described in more detail herein below. In these embodiments, the outer adhesive layer (130) can also comprise additives to block or absorb the UV radiation, as described hereinbelow.

For clarity, the ultra-thin layer of particulate UV blocking material (125) will not be shown in the figures hereinbelow.

Typically, the adhesive applied to the outer facet of the transfer tape (120) comprises an acrylic adhesive and the adhesive applied to the inner facet of the transfer tape (140) comprises a rubber-based adhesive. However, any UV-resistant and water-resistant adhesive of suitable strength can be used in the outer adhesive layer (120) and any water-resistant adhesive of suitable strength can be used in the inner adhesive layer (140). In some embodiments, the inner adhesive (140) has a strong initial-tack strength, in particular in field conditions, with a short time to build bond strength. In some embodiments, the outer adhesive builds up bond strength for up to 24-to-72 hours. In some embodiments, the initial tack-strength of the inner adhesive is >20 N/mm (as measured by loop tack). The outer adhesive layer (120) can comprise a UV-cured adhesive, a solvent-borne adhesive a water-borne adhesive or a hot-melt (solvent-less) adhesive.

The types of additives used to block the UV radiation from reaching the inner adhesive layer (140) will depend on the type of adhesive used in the outer adhesive layer (120). If the outer adhesive layer (120) comprises a UV-cured adhesive, the additives can block or absorb UVA and UVB radiation but must not block or absorb UVC radiation, which induces crosslinking of the adhesive.

The outer adhesive layer can also comprise components such as photostabilizers, exemplified by, but not limited to, HALS—hindered amine light stabilizers, as well as free radical scavengers and quenchers, which slow down the degradation of UVA/UVB absorbers and of the adhesive itself.

If the outer adhesive layer (120) is not UV-cured, it can additionally comprise physical light blockers, typically pigments such as, but not limited to, titanium oxide or zinc oxide.

In some variants of embodiments without a UV protective film (130), UV protection would be provided by an ultra-thin layer of particulate UV blocking material (FIG. 8, 125), with the layer thin enough to allow a large interface between the outer adhesive layer (120) and the inner adhesive layer (140), so that good bonding of the layers is achieved.

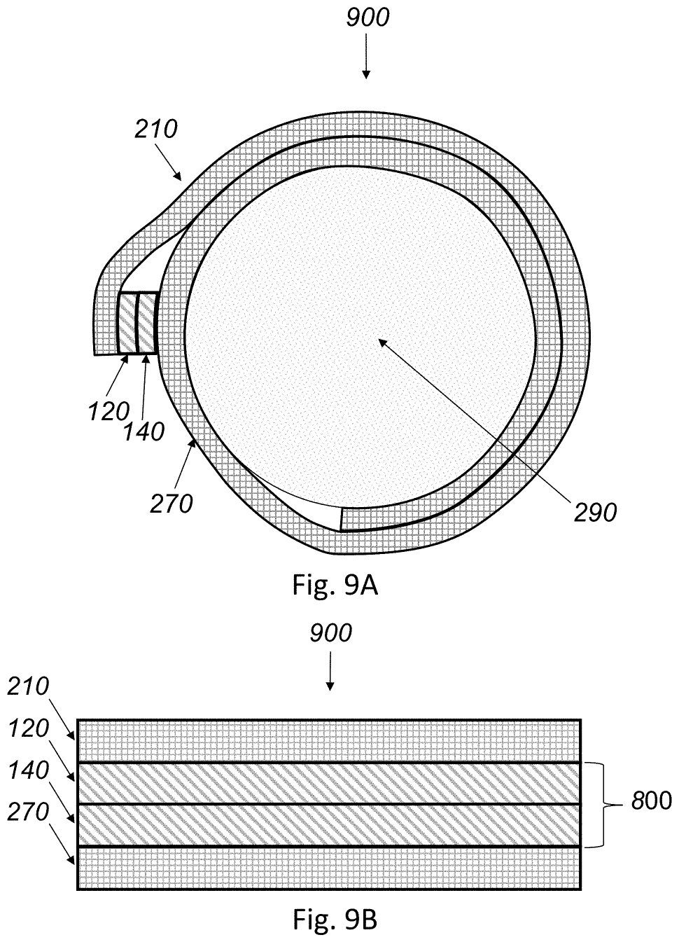

A protective wrap (900) comprising the transfer tape is shown wrapping an exemplary bale of cotton (not to scale) in FIGS. 9A-B. FIG. 9A schematically illustrates the protective wrap (900) as wrapped around the bale (290), while FIG. 9B schematically illustrates the layers making up the wrap (900). The bale of cotton (290) is surrounded by an inner wrap layer (270), with the wrap layer material selected from a wrapping material typical of those known in the art. Adhering to the outside of the end of the inner wrap layer (270) is the inner adhesive layer (140). The outer adhesive layer (120) bonds the inner wrap layer (140) and the outer wrap layer (210).

In preferred embodiments, the external releasable cover layers comprise glassine release liner. In other embodiments, they can comprise any flexible releasable film with sufficient strength to withstand handling.

In preferred embodiments, the internal release liner (carrier layer) comprises PET film. In other embodiments, it can comprise any flexible releasable film with sufficient strength to withstand being mechanically separated from the transfer tape.

As described above, the outer adhesive layer (120) has the following properties:
As an adhesive agent:
   high hot shear resistance;
   high hot/cold peel resistance;
   good bonding under pressure to a plastic film substrate after long dwell time (weeks);
As a material:
   high resistance to the elements, including wetness (humidity and rain) and sunlight (UV radiation).

As described above, the inner adhesive layer (140), which, in the final protective wrapping, is protected by at least one UV protective layer, has the following properties:
As an adhesive agent:
   high hot shear resistance;
   high hot/cold peel resistance;
   high cold tack;
   good immediate bonding to plastic film substrate
As a material:
   high resistance to wetness (humidity and rain).
   Some resistance to UV radiation.

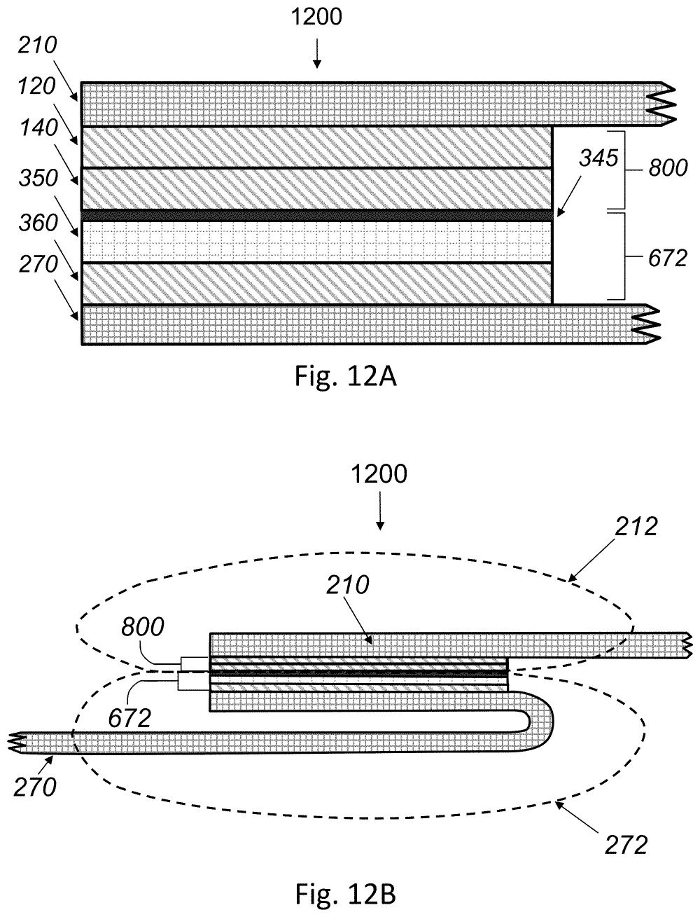

As described hereinabove, production of the wrapped product occurs in several stages, with the output of Stage 1 being a transfer tape product (1100, FIG. 11, below), the output of Stage 2 being a wrap-ready product (1200, FIG. 12A, below), and the output of Stage 3 being an object, such as a bale of cotton, wrapped in, and protected by, the product (900, FIG. 9A).

The exemplary production flow presented herein (Stages 1-3) for a transfer tape product (1100, FIG. 11, below) and, hence, a wrap material wherein UV protection for the inner adhesive (140) is provided by means other than an UV protective film (130) is but one option for producing the laminate; there are alternative routes which can be used.

In the exemplary production flow presented herein for a transfer tape product without UV protective film (800), Stage 1 has only two steps; there is no sub-product analogous to sub-product 2 (400), as this would entail a sub-product with an exposed adhesive layer. Therefore, the steps in Stage 1 for the exemplary production flow for the product without UV protective film (800) will be referred to as steps A and B.

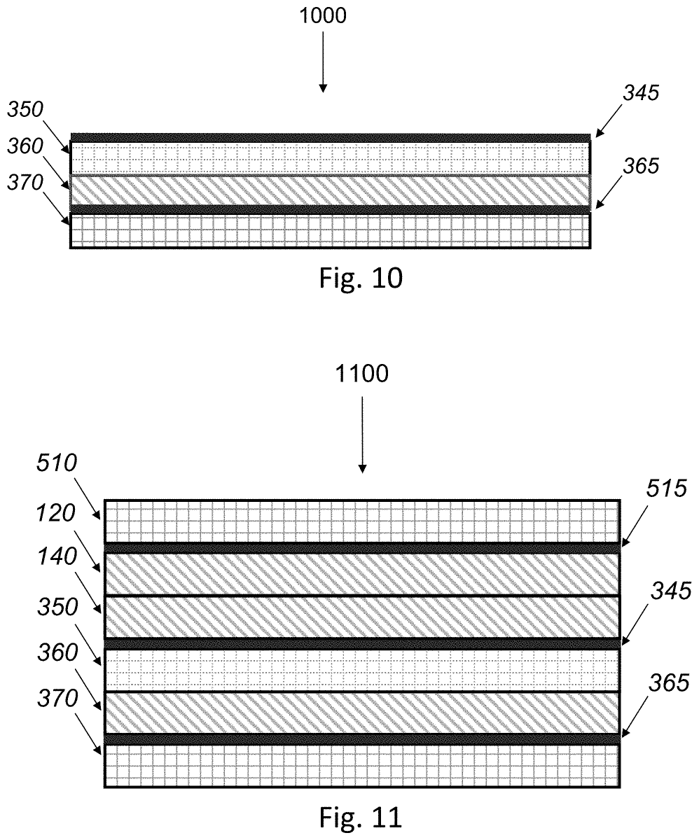

FIG. 10 shows the output of Step A of Stage 1, sub-product 1 (1000). Sub-product 1 (1000) is formed by coating a glassine release liner (the white glassine release liner) (370) with a release layer (365) on the release layer (365) side with about 30 gm/m² of permanent adhesive (360) (range 20-60 gm/m²), and laminating this with a siliconized PET release liner (350) with release layer (345), on its non-release layer side.

It should be noted that, in this exemplary production flow, sub-product 1 (1000) has a layer structure identical to that of sub-product 1 of Step 1 of Stage 1 (300) for the product with UV protective film (130).

FIG. 11 shows the output of Step B of Stage 1, a storable product, the transfer tape product (1100), comprising the transfer tape (800) between two release layers. The transfer tape product (1100) is formed by coating sub-product 1 (1000) on the siliconized release layer side 345 of the PET release liner with inner transfer adhesive(s) (140) (coat weight about 50-120 gm/m²). The inner transfer adhesive (140) is then coated with outer adhesive(s) (120) (coat weight about 20-60 gm/m²) and the outer adhesive(s) (120) is laminated with yellow glassine release liner (510), with the release side (515) of the yellow glassine release liner (510) facing the outer adhesive layer (120).

In preferred embodiments, the inner adhesive (140) is coated with an ultra-thin layer (125, not shown) of UV-protective particulate material, before the outer adhesive (120) is applied.

The transfer tape product (1100) can withstand handling, transportation and storage for an indefinite length of time (the transfer tape is guaranteed for 2 years from tape production until the end of use in the field) and it is envisaged that the transfer tape product (1200) will be marketed.

In order to form the protective wrap, two additional stages, Stage 2 and Stage 3, are required. It is intended that Stage 2, like Stage 1, occurs under controlled conditions, for example, in a customer's factory, where temperature and cleanliness are controlled and there is an absence of free water, although control of humidity is not necessary. In some embodiments, stage 2 addition comprises a step of building strength. Building strength can be conducted by an active process, such as curing, or by a passive step, such as time.

During stage 2, the white (370) and yellow (510) release liners are removed from the transfer tape product (500), after removal of the release liners (370, 510), the leading edge of one piece of wrap material (210, 270) is bonded to the freshly-exposed side of the permanent adhesive layer (360) on the inner side of the linking tape (800, 672), while the trailing edge of a second piece of wrap material (210, 270) is bonded to the freshly-exposed side of the outer adhesive layer (120). In some embodiments, following stag 2, the bond is left to strengthen for a period of at least 24 hours.

As described hereinabove, the portion of the linking tape (800, 672) bonded to the leading edge of a piece of wrap material (210, 270) is bonded to the outer side of the piece of wrap material (210, 270), while the portion of the linking tape (800, 672) bonded to the trailing edge of the piece of wrap material (210, 270) is bonded to the inner side of the piece of wrap material (210, 270).

The width of the transfer tape is preferably at least 75% of the width of the wrap material, so the transfer tape extends at least ¾ of the way across at each end of the wrap film. The transfer tape is preferably positioned such that its center is approximately at the center of the width of the wrap film.

As described hereinabove, using this method of production of wrap-ready material will result in a plurality of wraps linked end-to-end.

Removal of the release liners (370, 510) and attachment of the wrap material (210, 270) creates a wrap-ready product (1200), as shown in FIG. 12A. FIG. 12A shows only the portion of the wrap ready product (1200) comprising the linking tape (800, 672); at least a portion and preferably the majority of both the inner (270) and outer (210) wrap layers are not in contact with the linking tape (800, 672).

In FIG. 12A, the transfer tape, comprising the outer layers (800) of the linking tape (800, 672) are the layers (120, 140) which are bonded to the trailing edge of one piece of wrap material and which will remain adhered to the outer wrap layer (270) in the final product, while the inner layers (672) of the linking tape (800, 672) are the layers (350, 360) which are bonded to the leading edge of a second piece of wrap material and will remain adhered to the inner wrap layer (210) in the final product.

FIG. 12B shows a larger portion of the wrap ready product (600) comprising the linking tape (800, 672); the inner wrap layer 270 is folded back so that both the inner (270) and outer (210) wrap layers approach the transfer tape from the same side (in this non-limiting example, the right side).

The wrap-ready product can withstand handling, transportation, and storage for an indefinite length of time (it is guaranteed for 2 years). To be used, it is transported to the packing environment, usually an open field. In the field, the PET release liner 350 is removed, exposing the inner adhesive layer (140). The freshly-exposed adhesive layer (140) is then adhered to the wrap film (270), forming the final product, a protective wrap, as shown in FIG. 9.

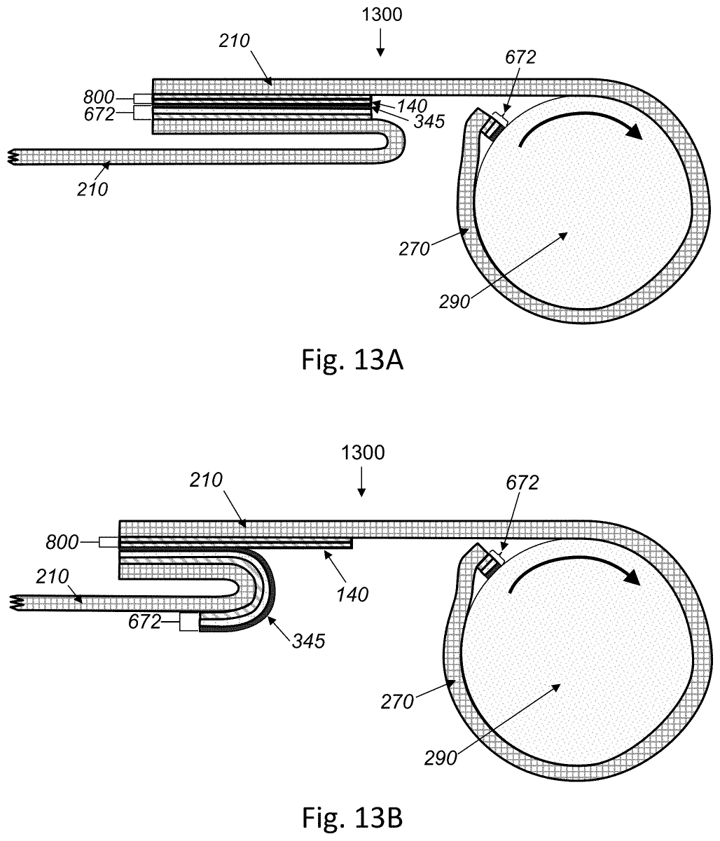

A schematic of an embodiment of an exemplary route (1300) for adhering the inner adhesive layer (140) to the wrap film (210, 270) is shown schematically in FIGS. 13A-B. The process is shown after the wrapping process has started; the first wrap (270) of the bale (290) is almost complete. The bale (290) is being rotated clockwise (CW), which pulls the wrap-ready product (1200) from a roll or other storage means known in the art (not shown).

In the exemplary embodiment shown schematically in FIGS. 13A and 13B, purely for convenience in illustration, the roll (not shown) is at the left and the wrap-ready product is drawn from the left towards the bale. In practice, the roll can be in any desired orientation relative to the bale and the wrap-ready product can be drawn towards the bale from any desired direction.

In FIG. 13A, the trailing edge (270) of the current wrap and the leading edge (210) of the next wrap are shown in a fully-joined condition. In FIG. 13B, the trailing edge (270) of the current wrap and the leading edge (210) of the next wrap have partially separated,

FIG. 13B shows the process at a slightly later stage. The linking tape (800, 672) is separating between the PET release layer (345) and the inner adhesive layer (140), exposing the inner adhesive (140) in the transfer tape layers (800), with the inner tape layers (672) remaining attached to the leading end of the inner wrap layer (270) of the next wrap film.

As the bale (290) continues to rotate, the transfer tape (800) and the outer tape layer (672) separate completely. The wrap film (210, 270) continues to wrap around the bale, forming an inner wrap layer (270) and an outer wrap layer (210). During completion of the second wrap, the transfer tape (800) at the end of the outer wrap layer (210) will be adhered to the inner wrap layer (270), thereby creating protective wrap 900.

It should be noted that a “tag” of wrap-ready product, comprising the inner tape layers (672), is left at the leading edge of the inner wrap layer (270).

Completion of two 360° rotations envelopes the bale (290) in a protective wrap (900) comprising two layers of wrapping film bonded together by a transfer tape (800). The transfer tape (800) which bonds the trailing end of the wrap film (270) to the inner wrap layer (210) comprises inner (140) and outer (120) adhesive layers, where the outer (120) was bonded under controlled conditions and the inner (140) bonded under field conditions. The transfer tape (800) also comprises UV protection for the inner (140) adhesive layer, either as part of the outer adhesive layer (120) or as an ultra-thin layer of particles between the at least two adhesive layers.

Therefore, the inner adhesive layer (140) is protected from wind, UV and wet, except at the edges, by the UV protection and the outer wrap layer, thereby providing a protective wrapping that can last up two years under field conditions.

Methods of producing a laminate structure comprising two or more contacting adhesive layers include, but are not limited to:
Using any conventional means known in the art for coating a film substrate for producing the first, inner layer (140), and applying the second, outer layer (120) using a non-contact coating method such as, but not limited to, curtain coating.
The two coatings (140, 120) would be performed consecutively inline (in one machine run). After the second coating, a laminating step would be performed, as described hereinabove.
Applying both adhesive layers simultaneously using a co-extruder nozzle, then laminating as described hereinabove.

One non-limiting method of producing a laminate structure comprising two or more contacting adhesive layers separated only by an ultrathin particulate layer comprises:
1. One adhesive layer (either outer (140) or inner (120)) would be produced using any conventional means known in the art for coating a film substrate.
2. An ultra-thin layer of solid blocking particles would be applied on top of the first adhesive layer, by means of spray coating or any other system known in the art for creating a thin coating of solid particles.
3. A second adhesive layer would then be coated on top of the particle layer, using a non-contact coating method such as, but not limited to, curtain coating.
   All three coating steps would be performed consecutively inline (in one machine run).
4. After the final adhesive coating, a laminating step would be performed, as described hereinabove.

As described hereinabove, the UV protection can comprise a UV protective film 130, UV protective material within the outer adhesive layer (120), an ultra-thin layer of particulate UV blocking material (125), and any combination thereof. For non-limiting example, in an embodiment where a UV protective film (130) forms the main means of UV protection, the UV protection provided by the UV protective film (130) can be reduced and the full measure of UV protection restored using UV blocking or UV absorbing constituents in the outer adhesive layer (120).

### Experimental

### Ex. 1

The build-up of tactile strength over time, by the two types of adhesives, have been evaluated, according to PEEL FTM 1—Adhesive detachment test, conducted at a 180° angle, and at 300 mm/min:

| | | | FTM1 (PE) | FTM1 (PE) | FTM1 (PE) |
|---|---|---|---|---|---|
| | | Bonding | 20 min | 24 hour | 240 hour |
| Type | | conditions | (N/25 mm) | (N/25 mm) | (N/25 mm) |
| Acrylic- | #1 | Controlled | 12 | 16 | 22 |
| based | | conditions | | | |
| Rubber | #2 | Field | 42 | 45 | 47 |
| Base | | conditions | | | |

This analysis shows that the build-up of take strength of the two types of adhesions is different and necessitates a different method of application, to enable the building up of sufficient strength for the product to remain protected by the wrap in field conditions. The table shows that this is especially true for acrylic-based adhesives, who demonstrate an initial low tack strength.

### Ex. 2

The effect of UV blocking or UV absorbing constituents to the outer adhesive, to improve the stability of the inner adhesive over time:

| | Initial | | 240 H | | 480 H | |
|---|---|---|---|---|---|---|
| uv | Max Force | Avg. Force | Max Force | Avg. Force | Max Force | Avg. Force |
| additives | (N/25 mm) | (N/25 mm) | (N/25 mm) | (N/25 mm) | (N/25 mm) | (N/25 mm) |
| With | 26.9 (26.4-27.65) | 21.9 (21.14-22.55) | 28.7 (28.31-29.38) | 26.6 (25.69-27.08) | 17.4 (15.20-19.17) | 15.51 (12.54-17.50) |
| Without | 29.8 (28.72-30.36) | 27.4 (26.35-28.30) | 4.4 (2.55-6.95) | 0.3 (0.29-0.41) | 1.0 (0.79-1.29) | 0.6 (0.41-0.83) |

1-32. (canceled)

33. In a protective wrap for a product to be left in the open air, a transfer tape 100 useful for joining said protective wrap's outer layer 210 to said protective wrap's inner layer 270, said transfer tape 100 having:
a. at least one acrylic-based adhesive 120 adapted to adhere at least one UV protective film 130 to said protective wrap's outer layer 210;
b. said at least one UV protective film 130 connected on a first side to said acrylic-based adhesive 120; and
c. at least one rubber-based adhesive 140 connected to a second side of said at least one UV protective film 130, said rubber-based adhesive 140 adapted to adhere to said protective wrap's inner layer 270.

34. The transfer tape of claim 33, wherein at least one of the following is being held true (a) the coat-weight of said acrylic-based adhesive 120 is in the range of 20 gm/m² and 60 gm/m²; (b) said transfer tape 100 is adherable to said protective wrap's outer layer 210 under industrial conditions and is adherable to said protective wrap's inner layer 270 under field conditions; (c) said first adhesive comprises a UV resistant adhesive; (d) the coat-weight of said rubber-based adhesive 140 is in the range of 50 gm/m² and 120 gm/m²; (e) said transfer tape additionally comprising a dispersion of particulate UV blocking material 125; further wherein said particulate UV blocking material 125 comprises at least one pigment; wherein said at least one pigment comprises a member of a group consisting of titanium oxide, zinc oxide, and any combination thereof.

35. The transfer tape of claim 33, wherein said at least one acrylic-based adhesive 120 additionally comprises at least one UV protective material; further wherein at least one of the following is being held true (a) said at least one UV protective material comprises an additive selected from a group consisting of: UVA reflectors, UVB reflectors, UVA absorbers, UVB absorbers, and any combination thereof; (b) said at least one UV protective material comprises at least one photostabilizer; said at least one photostabilizer comprises HALS (hindered amine light stabilizer); and any combination thereof.

36. The transfer tape of claim 33, wherein said one acrylic-based adhesive 120 has a bond build time of at least 24 hours and said rubber-based adhesive 140 is characterized as having a strong initial tack-strength.

37. The transfer tape of claim 36, wherein said rubber-based adhesive 140 is characterized as having and initial tack-strength of at least >20 N/mm.

38. A protective wrap for a product to be left in the open air comprising
a. an outer protective layer 210;
b. an inner protective layer 270; and
c. a transfer tape 100 for joining said outer and said inner protective layers
wherein said transfer tape 100 comprises at least one acrylic-based adhesive 120 adapted to adhere said at least one UV protective film 130 to said outer layer 210; at least one UV protective film 130 connected to a first side of said acrylic-based adhesive 120; and at least one rubber-based adhesive 140 connected to a second side of said at least one UV protective film 130.

39. The protective wrap of claim 38, wherein at least one of the following are being held true (a) the coat-weight of said acrylic-based adhesive 120 of said transfer tape 100 is in the range of 20 gm/m² and 60 gm/m²; (b) said protective wrap's outer layer 210 is adherable to said transfer tape 100 under industrial conditions and said protective wrap's inner layer 270 is adherable to said transfer tape 100 under field conditions; (c) said first adhesive comprises a UV resistant adhesive; (c) the coat-weight of said rubber-based adhesive 140 of said transfer tape 100 is in the range of 50 gm/m² and 120 gm/m²; (d) said protective wrap additionally comprising a dispersion of particulate UV blocking material 125; said particulate UV blocking material 125 comprises at least one pigment; further wherein said at least one pigment comprises a member of a group consisting of titanium oxide, zinc oxide and any combination thereof; and any combination thereof.

40. The protective wrap of claim 38, wherein said at least one acrylic-based adhesive 120 additionally comprises at least one UV protective material; further wherein at least one of the following is being held true (a) said at least one UV protective material comprises an additive selected from a group consisting of: UVA reflectors, UVB reflectors, UVA absorbers, UVB absorbers, and any combination thereof; (b) said at least one UV protective material comprises at least one photostabilizer; further wherein said at least one photostabilizer comprises HALS (hindered amine light stabilizer).

41. The protective wrap of claim 38, wherein said acrylic-based adhesive 120 is characterized as having a strength building period of at least 24 hours and said rubber-based adhesive 140 is characterized as having a strong initial tack-strength.

42. The protective wrap of claim 41, wherein said rubber-based adhesive 140 is characterized as having and initial tack-strength of at least >20 N/mm.

43. In a protective wrap for a product to be left in the open air, a transfer tape 800 useful for joining said protective wrap's outer layer 210 to said protective wrap's inner layer 270, said transfer tape 800 having:
a. at least one acrylic-based adhesive 120 adapted to adhere to said protective wrap's outer layer 210; and
b. at least one rubber-based adhesive 140 connected to a second side of said at least one acrylic-based adhesive 120, said rubber-based adhesive 140 adapted to adhere to said protective wrap's inner layer 270
wherein at least one of the following is held true: said at least one acrylic-based adhesive 120 comprises at least one UV protective material, and at least one layer of particulate UV blocking material 125 is disposed between said acrylic-based adhesive 120 and said rubber-based adhesive 140.

44. The transfer tape of claim 43, wherein at least one of the following is being held true (a) said particulate UV blocking material 125 comprises at least one pigment; (b) said at least one pigment comprises a member of a group consisting of titanium oxide, zinc oxide and any combination thereof; said at least one UV protective material comprises an additive selected from a group consisting of: UVA reflectors, UVB reflectors, UVA absorbers, UVB absorbers, and any combination thereof; (c) said at least one UV protective material comprises at least one photostabilizer; said at least one photostabilizer comprises HALS (hindered amine light stabilizer); (d) said transfer tape 800 is adherable to said protective wrap's outer layer 210 under industrial conditions and to said protective wrap's inner layer 270 under field conditions; (e) the coat-weight of said acrylic-based adhesive 120 is in the range of 20 gm/m² and 60 gm/m²; (f) said first adhesive comprises a UV resistant adhesive; (g) the coat-weight of said rubber-based adhesive 140 is in the range of 50 gm/m² and 120 gm/m²; and any combination thereof.

45. The transfer tape of claim 43, wherein said acrylic-based adhesive 120 is characterized as having a strength building period of at least 24 hours and said rubber-based adhesive 140 is characterized as having a strong initial tack-strength.

46. The transfer tape of claim 45, wherein said rubber-based adhesive 140 is characterized as having and initial tack-strength of at least >20 N/mm.
